(19) United States
(12) Patent Application Publication
(10) Pub. No.: US 2026/0145096 A1
(43) Pub. Date: May 28, 2026

(54) BUBBLE PRODUCING TOY

(71) Applicant: DISNEY ENTERPRISES, INC., Burbank, CA (US)

(72) Inventor: Anil Ramdeholl Phagoo, Winter Garden, FL (US)

(21) Appl. No.: 18/958,368

(22) Filed: Nov. 25, 2024

(51) Int. Cl. A63H 33/28; A63H 5/00; A63H 29/22; A63H 33/22; F21V 33/00

(52) U.S. Cl. CPC A63H 33/28; A63H 5/00; A63H 33/22; F21V 33/008; A63H 29/22

(57) ABSTRACT

A toy may include a wand defining a handle for gripping by a user to hold the toy, and a bubble generator configured to produce bubbles or foam. The bubble generator may be coupled to the wand, such as the handle. The toy may include an active element configured to provide an action along the wand. The active element may include a spinner or string configured to rotate relative to the wand, such as around the wand. The toy may include a sound generator and at least one lighting element, such as multiple lighting elements. The lighting elements may be arranged along the wand and/or the spinner/string. The toy may include a transparent enclosure coupled to the wand. The toy may include an entertainment feature configured to provide an action along the wand. The entertainment feature may include a spinner, a string, or a snow globe.

### FIELD

The present application relates to novelty toys, such as toys that produce bubbles.

### BACKGROUND

Toys that produce bubbles are known. However, such toys are limited in generating bubbles only. For example, such toys do not include active elements that provide additional visual interest and action.

### BRIEF SUMMARY

In one example, a toy includes a wand defining a handle for gripping by a user to hold the toy, a bubble generator configured to produce bubbles or foam, and an active element configured to provide an action along the wand.

Optionally, the active element includes a spinner or string, wherein the action includes a rotation of the spinner or string around a longitudinal axis of the wand. The active element may include the string, with the string coupled to a ring configured to rotate about the longitudinal axis of the wand. The active element may include the spinner, with the spinner magnetically coupled or mechanically coupled to a ring configured to rotate about a longitudinal axis of the wand. The spinner may be mechanically coupled to the ring by one or more spokes.

Optionally, the active element includes a transparent enclosure coupled to the wand. The transparent enclosure may be at least partially filled with liquid having particles suspended therein, with the action including movement of the particles along the wand. The toy may include a mixer or an agitator configured to stir or mix the liquid to cause the movement of the particles.

Optionally, the toy includes a sound generator coupled to the wand, wherein the sound generator is configured to generate sounds synchronized with at least one of the action of the active element or a production of bubbles or foam by the bubble generator.

Optionally, the toy includes at least one lighting element coupled to the wand. The at least one lighting element may be configured to illuminate the bubbles or foam produced by the bubble generator. The at least one lighting element may be configured to generate light synchronized with the action of the active element or a production of bubbles or foam by the bubble generator.

Optionally, the toy is configured to be selectively activated to produce bubbles or foam, actuate the active element, or both produce bubbles or foam and actuate the active element.

Optionally, the toy includes a thematic character coupled to or located within the active element.

In another example, a toy includes a wand defining a handle for gripping by a user to hold the toy, a bubble generator configured to produce bubbles or foam, and a spinner or a string configured to rotate relative to the wand.

Optionally, the spinner or the string is coupled to a ring configured to rotate about a longitudinal axis of the wand. The toy may include the spinner, with the spinner magnetically coupled or mechanically coupled to the ring. The spinner may be mechanically coupled to the ring by one or more spokes.

In another example, a toy includes a wand defining a handle for gripping by a user to hold the toy, a bubble generator configured to produce bubbles or foam, and a transparent enclosure coupled to the wand. The transparent enclosure is at least partially filled with liquid having particles suspended therein. The liquid is configured to be agitated to cause movement of the particles within the liquid.

Optionally, the toy includes an agitator configured to agitate the liquid to cause movement of the particles within the liquid.

In addition to the exemplary aspects and embodiments described above, further aspects and embodiments will become apparent by reference to the drawings and by study of the following description.

### BRIEF DESCRIPTION OF THE DRAWINGS

FIG. 1 illustrates a schematic view of a bubble producing device.

FIG. 2 illustrates an example implementation of a handheld bubble producing device.

FIG. 3 illustrates an example coupling of a spinner to a handheld bubble producing device.

FIG. 4 illustrates another example coupling of a spinner to a handheld bubble producing device.

FIG. 5 illustrates another example coupling of a spinner to a handheld bubble producing device.

FIG. 6 illustrates another example implementation of a handheld bubble producing device.

FIG. 7 illustrates another example implementation of a handheld bubble producing device.

### DETAILED DESCRIPTION

The disclosed bubble producing toy provides a combination of bubble generation and other entertainment features or elements, such as moving (e.g., spinning, falling) elements, in a handheld toy. As one example, a spinner or other active element may be configured to move relative to a handle during bubble production, such as to provide an additional element of entertainment or fun. For example, the toy may be selectively activated to produce bubbles, rotate the spinner, or produce bubbles and rotate the spinner at the same time. As another example, a snow globe element may include a transparent enclosure at least partially filled with liquid having particles suspended therein. The liquid may be agitated (e.g., via an agitator) to cause movement of the particles within the liquid. As another example, one or multiple strings may be coupled to rotate around the handle. The strings may be flexible and lighted (e.g., a string or strip light) and couple to one or more thematic characters. The toy may include lights and sounds, such as synchronized with movement of the entertainment features and/or with bubble production. Portions of the toy may be modular, such as to replace elements or customize the toy to user preference.

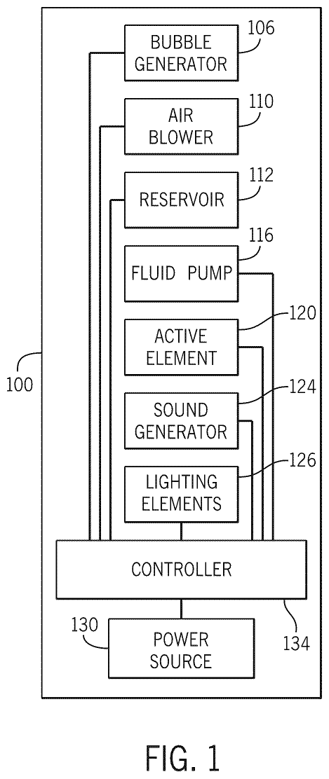

Along these lines, FIG. 1 illustrates a schematic view of an example toy 100. The toy 100 may include one or more elements to provide a desired experience for a user, such as a child (e.g., for entertainment, to stimulate creativity or imagination, to develop physical and mental skills, to develop cognitive and motor skills, or other purposes). For example, the toy 100 may include elements that move or perform other actions.

In examples, the toy 100 includes a bubble generator 106. The bubble generator 106 may include various configurations to produce bubbles or foam. For instance, the bubble generator 106 may include one or more rings (e.g., bubble dispensing rings) configured to form bubbles with air movement (e.g., as the rings move against air, as air is blown through the rings, etc.). For example, bubble solution may be applied to the rings and bubbles may form as air is blown through a bubble solution film extending across the center of the rings, such as in a conventional manner. Depending on the application, the bubbles may be microbubbles, large diameter bubbles, smoke-filled bubbles, a string of bubbles, multiple bubbles in a variety of sizes, spherical bubbles, elongated bubbles, foam bubbles that appear like snow, etc. Such examples are illustrative only, and the bubble generator 106 may produce bubbles using different means and configurations.

The bubble generator 106 may be coupled to or include an air blower 110. The air blower 110 may include a fan that produces an air stream with sufficient velocity to create a bubble (e.g., to push the bubble solution film through the rings). The fan may be powered by a motor. In some examples, the air produced by the fan may be routed to the bubble generator 106 via an air duct. In other examples, the fan may be positioned adjacent the bubble generator 106, such as proximate to the rings so that an air duct may be omitted.

The bubble generator 106 may be coupled to a reservoir 112, such as a bubble solution reservoir. The reservoir 112 may be configured to hold liquid, such as bubble solution, which transforms into bubbles via the bubble generator 106. The reservoir 112 may be refillable. For example, the reservoir 112 may be removed from the toy 100 for refilling of bubble solution, or the reservoir 112 may include a fill port to adjust the level of bubble solution in the reservoir 112 (e.g., to add or remove bubble solution). Additionally, or alternatively, the reservoir 112 may be replaceable. For example, the reservoir 112 may be a consumable product, such as a bottle of bubble solution. In such examples, an empty bottle of bubble solution may be replaced with another bottle of bubble solution.

One or more tubes may fluidically couple the reservoir 112 to the bubble generator 106, such as to carry bubble solution from the reservoir 112 to the bubble generator 106. In such examples, the toy 100 may include a fluid pump 116. Depending on the application, the fluid pump 116 may be positioned in the reservoir 112, adjacent the reservoir 112, or adjacent the bubble generator 106. For example, the fluid pump 116 may be included as part of the bubble generator 106 or the reservoir 112. The fluid pump 116 may be driven by the same motor that drives the air blower 110, or the fluid pump 116 may include a separate motor.

In examples, the toy 100 includes an active element 120. The active element 120 may be configured to move, such as spin, rotate, slide, or otherwise. For example, the active element 120 may include a spinner that rotates during operation of the toy 100, as described more fully below. In other examples, the active element 120 may include other configurations to generate an entertainment effect or feature. For instance, the active element 120 may include movable elements or features providing visual interest (e.g., a snow globe, a movable character, haptic/tactile elements, etc., without intent to limit). In examples, the active element 120 may move or operate alone or in combination with bubbles being produced by the bubble generator 106. For example, the toy 100 may be configured to be selectively activated to produce bubbles, actuate the active element 120, or both produce bubbles and actuate the active element 120. The active element 120 may be driven by hand or by a motor. The active element 120 may be driven by the same motor that drives the air blower 110 and/or fluid pump 116, or the active element 120 may include a separate motor.

With continued reference to FIG. 1, the toy 100 may optionally include a sound generator 124 and/or at least one lighting element 126 (e.g., multiple lighting elements 126). The sound generator 124 may be configured to create sounds, such as including a speaker or other element that produces sound. For example, the sound generator 124 may generate or play music, monologue (e.g., catch phrases, slogans, or other words and sentences), sound effects, or other audio, such as complementary to toy type, toy operation, toy configuration, etc. In one example, the sound generator 124 may generate or play sounds synchronized with movement of the active element 120 and/or the generation of bubbles. For instance, the sound generator 124 may generate or play sounds that match the speed, rotation, or other movement of the active element 120.

The lighting elements 126 may be configured to generate light, such as a light-emitting diode (LED), a lightbulb, a lamp, glow elements, phosphorescent materials, or otherwise. In one example, the lighting elements 126 may generate light synchronized with movement of the active element 120 and/or the generation of bubbles. For instance, the lighting elements 126 may be configured to illuminate the bubbles produced by the bubble generator 106. The lighting elements 126 may generate light matching the speed, rotation, or other movement of the active element 120.

In examples, the toy 100 includes a power source 130. The power source 130 may include a battery. The battery may be disposable or rechargeable and have substantially any configuration. For example, the battery may be an alkaline battery, a nickel-metal hydride (NiMH) battery, a nickel-cadmium (NiCad) battery, a lithium-ion battery, or another type of battery. The battery may be rechargeable through a charger coupled to an AC (alternating current) power source, DC (direct current) power source, a solar panel, etc. The power source 130 may be sized to power the various components of the toy 100, such as the bubble generator 106, the air blower 110, the fluid pump 116, the motor, the active element 120, the sound generator 124, the lighting elements 126, or any combination thereof.

In examples, the toy 100 includes a controller 134. The controller 134 may include one or more processors, logic devices, or circuitry that control the various electrical/electronic operations of the toy 100. The controller 134 may include hardware for executing instructions, such as those making up a computer program. For example, the controller 134 may execute instructions for various components of the toy 100 or other systems described herein. The controller 134 may include circuity for performing various processing functions, such as executing specific software to perform specific tasks (e.g., operate the bubble generator 106, active element 120, air blower 110, sound generator 124, lighting elements 126, or fluid pump 116, or other operations described herein). In examples, the controller 134 may be coupled to a user switch, such as an on/off button, a mode select button, or the like. Additionally, or alternatively, the controller 134 may be coupled to one or more sensors monitoring operations of the toy 100, such as a fluid level sensor in the reservoir 112, a sensor for detecting movement of the active element 120, motor encoders, and/or feedback sensors, among other sensors.

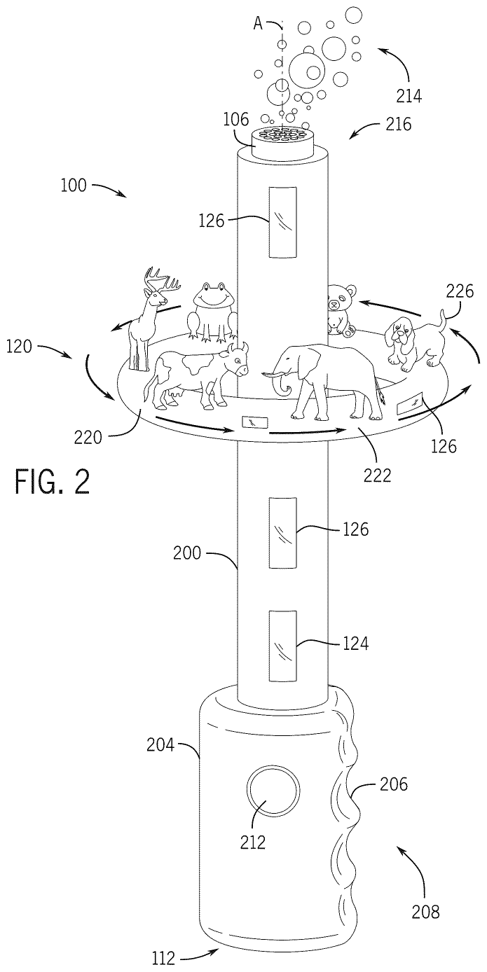

FIG. 2 illustrates an example handheld implementation of the toy 100. The toy 100 may include a wand 200. The wand 200 may be configured to be gripped by a user to hold the toy 100. For example, the wand 200 may define a handle 204 to hold the toy 100 (e.g., for gripping by a user to hold the toy 100). The handle 204 may be shaped to fit comfortably in the user's hand. For instance, the handle 204 may include finger grooves 206 or other indentations or shapes to ergonomically fit the handle 204 to the user's hand. The handle 204 may be positioned along a length of the wand 200, such as at a bottom end 208 of the wand 200.

The wand 200 may include one or more functional elements of the toy 100. For example, the sound generator 124 may be coupled to the handle 204, such as a speaker of the sound generator 124 positioned on the wand 200. Additionally, or alternatively, at least one lighting element 126 may be coupled to the handle 204, such as lighting elements 126 placed along a length of the wand 200. The wand 200 may include an on/off button 212. The on/off button 212 may turn the toy 100 on or off, and, in some examples, may activate one or more modes of operation. For instance, using the on/off button 212, the toy 100 may be selectively activated to produce bubbles, actuate the active element 120, or both produce bubbles and actuate the active element 120. In other examples, the wand 200 may include a mode button separate from the on/off button 212.

The reservoir 112 may be coupled to the wand 200. For example, the reservoir 112 may be secured to the bottom end 208 of the wand 200. In such examples, the reservoir 112 may have a flat bottom, so that the toy 100 can be placed to stand on a surface. In some examples, the reservoir 112 may define the handle 204.

The bubble generator 106 may be coupled to the wand 200 or handle 204. For instance, the bubble generator 106 may be configured to produce bubbles 214 at a top end 216 of the wand 200. Components of the bubble generator 106 may be positioned within the wand 200. For example, one or more tubes, fluid pump 116, and/or the air blower 110 may be housed within the wand 200.

The active element 120 may be configured to move relative to the wand 200 or handle 204, such as during a production of bubbles 214 by the bubble generator 106. As one example, the active element 120 may include a spinner 220 configured to rotate around the wand 200 or handle 204. For instance, the wand 200 may define a longitudinal axis A, with the spinner 220 configured to rotate around the longitudinal axis A. The spinner 220 may include a closed ring 222 extending around the wand 200, although other configurations are contemplated. In examples, the bubble generator 106 and spinner 220 may be coupled to the same end of the wand 200, such as to the top end 216. A motor may be utilized to rotate the spinner 220. The motor for driving rotation of the spinner 220 may be configured to also drive the bubble generator 106, although other configurations are contemplated. In some examples, lighting elements 126 may be positioned along the spinner 220, such as located along the closed ring 222.

In some examples, the toy 100 may include thematic characters 226 coupled to the spinner 220. The thematic characters 226 may be figurines, statuettes, molded figures, or the like, such as representing characters from movies, shows, books, etc. The thematic characters 226 may be removable, such as replaceable with the same or different characters to provide a degree of modularity for replacement or user customization. The thematic characters 226 may be secured to the spinner 220 using fasteners and/or via magnetism.

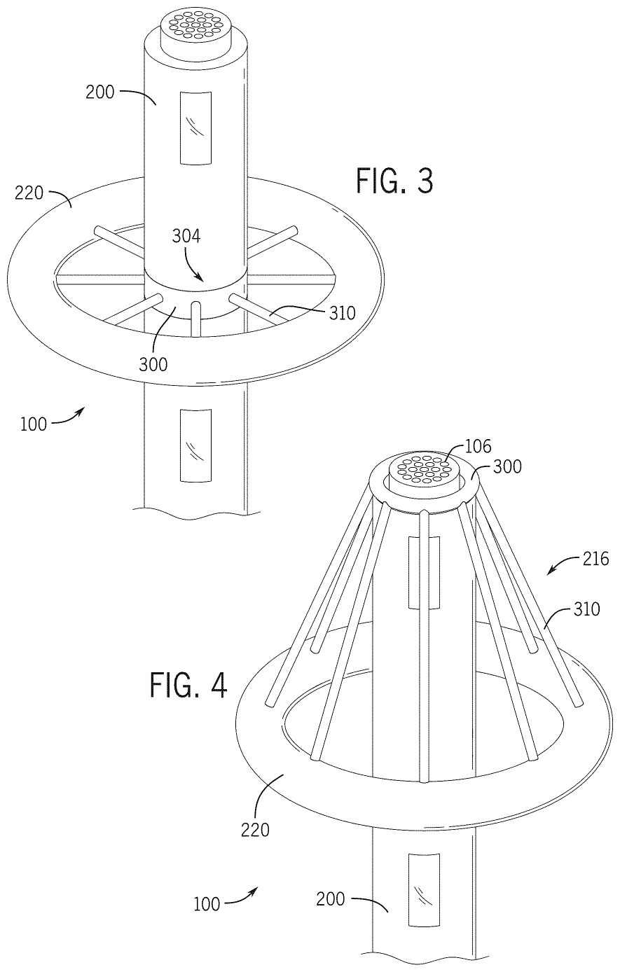

FIG. 3 illustrates an example coupling of the spinner 220 to the wand 200. In some implementations, the toy 100 may include a ring 300 configured to rotate about the longitudinal axis of the wand 200. The wand 200 may include a groove 304, such as formed in the housing or exterior surface of the wand 200. The groove 304 may extend annularly around the wand 200, such as annularly around the longitudinal axis. The ring 300 may be positioned within the groove 304, such as the ring 300 rotating in the groove 304. In some examples, one or more bearings may be provided to facilitate rotation of the ring 300 about the wand 200.

In examples, the spinner 220 may be mechanically coupled to the ring 300. For example, one or more elements or structures may extend to couple the spinner 220 to the ring 300. As one implementation, one or more spokes 310 may extend between the spinner 220 and the ring 300, such as to position the spinner 220 relative to the ring 300. The spokes 310 may extend radially or generally radially from the ring 300 to the spinner 220. The spokes 310 may be rigid or semi-rigid.

FIG. 4 illustrates another example coupling of the spinner 220 to the wand 200. In some implementations, the ring 300 may be positioned at the top end 216 of the wand 200, such as at or near the bubble generator 106. The spokes 310 may extend to suspend the spinner 220 from the top end 216. For example, the spokes 310 may extend, at least partially, along a length of the wand 200 (e.g., towards the bottom end 208), to position the spinner 220 between the top end 216 and the bottom end 208. In some examples, the spokes 310 may be flexible.

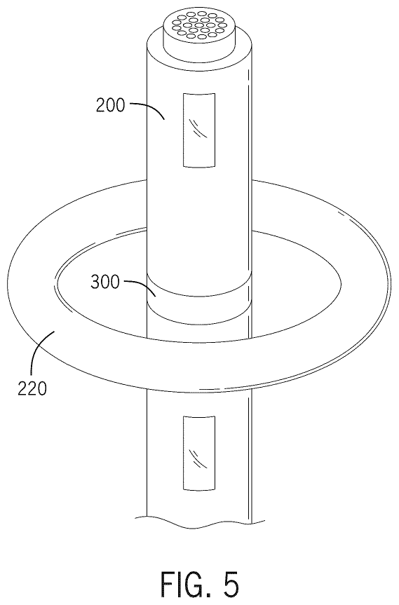

FIG. 5 illustrates another example coupling of the spinner 220 to the wand 200. In some implementations, the spinner 220 may be magnetically coupled to the ring 300. For example, the ring 300 may include or be formed of a first magnetic material or magnet, and the spinner 220 may include or be formed of a second magnetic material or magnet. The first magnetic material or magnet of the ring 300 may be attracted to the second magnetic material or magnet of the spinner 220. In some examples, the spinner 220 may engage the ring 300 when coupled. In other examples, a space may be defined between the spinner 220 and the ring 300 when coupled. In such examples, the spinner 220 may appear to float as it rotates or spins around the wand 200.

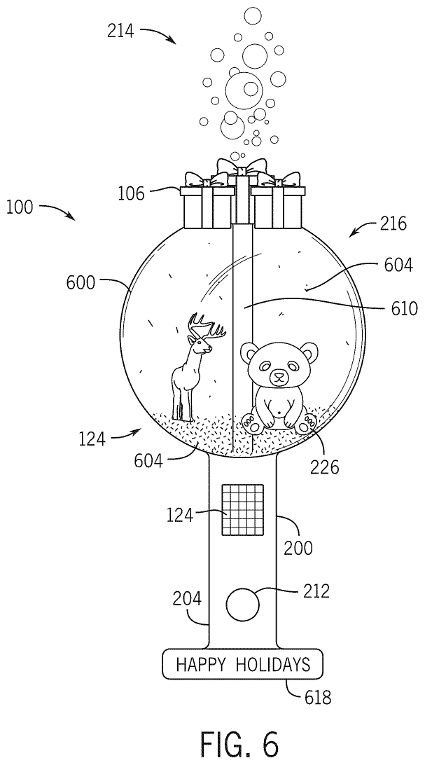

FIG. 6 illustrates another example handheld implementation of the toy 100. The active element 120 may include a transparent enclosure 600 (e.g., a snow globe; hereinafter “enclosure” without intent to limit). The enclosure 600 may be coupled to the top end 216 of the wand 200. For example, the enclosure 600 may be positioned above the handle 204 along the wand 200, such as above the sound generator 124, lighting elements 126, and/or on/off button 212. The enclosure 600 may be spherical, as shown, or the enclosure 600 may include other shapes.

The enclosure 600 may be partially or completely filled with liquid (e.g., water, a mixture of water and glycerin, a mixture of water and ethylene glycol, or any other transparent or semi-transparent liquid) and include particles 604 suspended in the liquid. The liquid may be clear or may be tinted, provided the tint is light enough for the user to see the particles 604 and any other contents suspended or provided in the liquid within the enclosure 600. The particles 604 may mimic or give the appearance of falling snow, such as when the enclosure 600 is shaken or the liquid agitated. The particles 604 may be glitter or other iridescent material. In some examples, the toy 100 may include a mixer or agitator to stir or mix the liquid, such as to move the particles 604 within the liquid. In other examples, the particles 604 are moved within the liquid by the user shaking the toy 100. In some examples, the enclosure 600 may include a scene, such that the particles 604 give the appearance of snow falling onto the scene. As a result, the enclosure 600 may provide an entertainment feature for a user, such as an action along the wand 200. Although described as a snow globe, the enclosure 600 may include other configurations to provide differing entertainment or actions.

The bubble generator 106 may be coupled at the top of the enclosure 600. In such examples, the bubble generator 106 may disperse bubbles, artificial snowflakes, or foam at the top of the wand 200. In some examples, a tube 610 may extend through the enclosure 600, such as to dispense bubbles, to connect the reservoir 112 to the bubble generator 106, etc. In other examples, the enclosure 600 may define the reservoir 112 itself. In some examples, one or more thematic characters 226 may be coupled to or located within the enclosure 600. The thematic characters 226 may be removable, such as replaceable with the same or different characters to provide a degree of modularity for replacement or user customization. In this manner, the thematic characters 226 may be coupled to an entertainment feature of the toy 100.

In some examples, the toy 100 may be themed, such as to a season, a character, a franchise, or the like. In such examples, the various elements or components of the toy 100 may match or support the theme. In FIG. 6, the toy 100 is themed for the holidays (e.g., Christmas), although other themes are contemplated. In such examples, the bubble generator 106 may be shaped like gifts, and the wand 200 may include indicia 618 (e.g., words or greetings), such as at the handle 204 or at other locations.

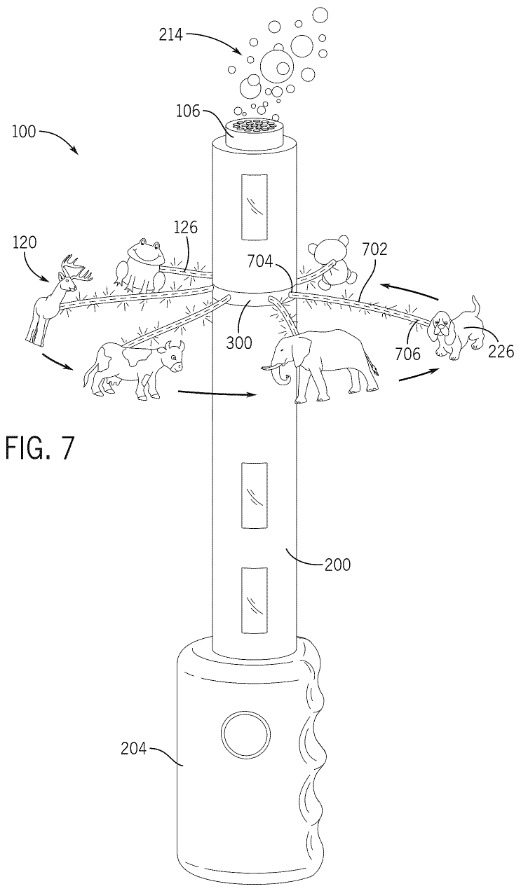

FIG. 7 illustrates another example handheld implementation of the toy 100. The active element 120 may include one or more strings 702 that rotate around the wand 200. Each string 702 includes opposing first end 704 (proximal to the wand 200) and second end 706 (distal to the wand 200). The first end 704 of each string 702 may be coupled to the ring 300, such as a plurality of strings 702 spaced annularly along the ring 300 at their first ends 704. The second end 706 of each string 702 may be coupled to a thematic character 226 or another element. In such examples, rotation of the ring 300 may rotate the strings 702 and thematic characters 226 about the wand 200. Each string 702 may be flexible or loose, such that absent rotation of the active element 120 about the wand 200, the strings 702 may droop downwards towards the handle 204. The strings 702 may straighten to extend radially from the wand 200 during rotation of the active element 120 about the wand 200, such as due to centrifugal force.

In some examples, the strings 702 may provide a lighting effect. For instance, the strings 702 may include or be defined at least partially by a lighting element 126 (e.g., a string light, a strip light, etc.). In such examples, the strings 702 may be lighted, such as during rotation of the strings 702 about the wand 200. One or more lighting characteristics of the strings 702 may be based on a configuration of the toy 100. For example, an intensity of light may be adjusted based on the rotational speed of the strings 702 about the wand 200 (e.g., increasing light intensity with increasing rotational speed, and vice-versa), or the light may be adjusted based on actuation of the bubble generator 106 (e.g., producing one color or pattern of light when the bubble generator 106 is actuated, producing another color or pattern of light when the bubble generator 106 is deactivated, etc.). In some examples, the light produced by the strings 702 may illuminate or otherwise highlight the bubbles 214 produced by the bubble generator 106. As a result, the strings 702 may provide an entertainment feature for the user, such as rotating around the wand 200 and/or providing a lighting or other visual effect.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A toy comprising:
a wand defining a handle for gripping by a user to hold the toy;
a bubble generator configured to produce bubbles or foam; and
an active element configured to provide an action along the wand.

2. The toy of claim 1, wherein the active element comprises a spinner or string, and wherein the action comprises a rotation of the spinner or string around a longitudinal axis of the wand.

3. The toy of claim 2, wherein the active element comprises the string, and the string is coupled to a ring configured to rotate about the longitudinal axis of the wand.

4. The toy of claim 2, wherein the active element comprises the spinner, and the spinner is magnetically coupled or mechanically coupled to a ring configured to rotate about a longitudinal axis of the wand.

5. The toy of claim 4, wherein the spinner is mechanically coupled to the ring by one or more spokes.

6. The toy of claim 1, wherein the active element comprises a transparent enclosure coupled to the wand.

7. The toy of claim 6, wherein the transparent enclosure is at least partially filled with liquid having particles suspended therein, and the action comprises movement of the particles along the wand.

8. The toy of claim 7, further comprising a mixer or an agitator configured to stir or mix the liquid to cause the movement of the particles.

9. The toy of claim 1, further comprising a sound generator coupled to the wand, wherein the sound generator is configured to generate sounds synchronized with at least one of the action of the active element or a production of bubbles or foam by the bubble generator.

10. The toy of claim 1, further comprising at least one lighting element coupled to the wand.

11. The toy of claim 10, wherein the at least one lighting element is configured to illuminate the bubbles or foam produced by the bubble generator.

12. The toy of claim 10, wherein the at least one lighting element is configured to generate light synchronized with the action of the active element or a production of bubbles or foam by the bubble generator.

13. The toy of claim 1, wherein the toy is configured to be selectively activated to produce bubbles or foam, actuate the active element, or both produce bubbles or foam and actuate the active element.

14. The toy of claim 1, further comprising a thematic character coupled to or located within the active element.

15. A toy comprising:
a wand defining a handle for gripping by a user to hold the toy;
a bubble generator configured to produce bubbles or foam; and
a spinner or a string configured to rotate relative to the wand.

16. The toy of claim 15, wherein the spinner or the string is coupled to a ring configured to rotate about a longitudinal axis of the wand.

17. The toy of claim 16, wherein the toy comprises the spinner, and the spinner is magnetically coupled or mechanically coupled to the ring.

18. The toy of claim 17, wherein the spinner is mechanically coupled to the ring by one or more spokes.

19. A toy comprising:
a wand defining a handle for gripping by a user to hold the toy;
a bubble generator configured to produce bubbles or foam; and
a transparent enclosure coupled to the wand,
wherein the transparent enclosure is at least partially filled with liquid having particles suspended therein,
wherein the liquid is configured to be agitated to cause movement of the particles within the liquid.

20. The toy of claim 19, further comprising an agitator configured to agitate the liquid to cause movement of the particles within the liquid.
